(19) United States
(12) Patent Application Publication
(10) Pub. No.: US 2013/0212950 A1
(43) Pub. Date: Aug. 22, 2013

(54) GRID-TYPE SAFETY GATE

(71) Applicant: Indowoods SA, (US)

(72) Inventors: Michel BERTSCH, Gaaden (AT); Sébastien BOUQUET, Brussels (BE)

(73) Assignee: INDOWOODS SA, Brussels (BE)

(21) Appl. No.: 13/837,558

(22) Filed: Mar. 15, 2013

Related U.S. Application Data
(63) Continuation of application No. PCT/EP2011/065502, filed on Sep. 7, 2011.

(30) Foreign Application Priority Data
Sep. 15, 2010 (DE) DE102010045433.8

(51) Int. Cl. E06B 11/02

(52) U.S. Cl. CPC E06B 11/02
USPC 49/464

(57) ABSTRACT

A safety gate for children or pets includes a barrier member with a predefined width for barring an opening with a larger width between stationary structures, at least one holding member for fixing the barrier member at the structures, and at least a first extension part provided between the holding member and the barrier member for bridging over at least a part of a difference between the width of the opening and the width of the barrier member. The extension part comprises at least one section with a stop member. The section extending in a longitudinal direction and being insertable into a support opening by an insertion depth. The stop member abuts selectably in a first insertion depth and in at least a second insertion depth which is different from the first insertion depth.

This nonprovisional application is a continuation of International Application No. PCT/EP2011/065502, which was filed on Sep. 7, 2011, and which claims priority to German Patent Application No. DE 10 2010 045 433.8, which was filed in Germany on Sep. 15, 2010, and which are both herein incorporated by reference.

### BACKGROUND OF THE INVENTION

1. Field of the Invention

The present invention relates to safety gate, in particular for children and pets.

2. Description of the Background Art

U.S. Pat. No. 4,685,247 A describes a safety gate for children and pets which can be jammed between the posts of a doorframe by means of clamps. An extension can be plugged onto the safety grid for adapting to the width of the doorframe, said extension then itself carrying the clamps for the jamming with the door frame.

### SUMMARY OF THE INVENTION

It is an object of the present invention to provide a safety gate, which, in an easy and safe manner, can be adjusted to different widths of an opening to be barred.

In an embodiment the object is achieved by a safety gate for children or pets, whereby the safety gate includes a barrier member with a predefined width for barring an opening with a larger width between stationary structures, at least one holding member configured to fix the barrier member at the structures, and at least a first extension part provided between the holding member and the barrier member for bridging over at least a part of a difference between the width of the opening and the width of the barrier member. The extension part comprises at least one section with a stop member, the at least one section configured to extend in a longitudinal direction and configured to be insertable into a support opening by an insertion depth. The stop member abuts selectably in a first insertion depth and in at least a second insertion depth, which is different from the first insertion depth.

Via the selectable stop of the first extension part in at least two different insertion depths, a multiple function of the extension part is provided in an embodiment, leading to a small number of parts and to a simple assembly.

Stationary structures can be understood as all structures which limit a passageway and are suitable for the fixing of a safety gate, like for instance door posts, walls, banisters or the like.

A barrier member can be understood as any element of the safety gate which is at least partially blocking the passageway. For example, it may be a frame with a door pivotably received therein, or even just a solid plate or a rigid grid. Generally, a safety gate in the sense of the present invention is not just understood as a structure with grid rods, but it might be any other embodiment of a passage blockade like e.g. a wooden plate, a transparent plastic plate or the like.

The holding members in the sense of the invention might be any suitable structure for the frictional, positive or else connection of the safety gate with the stationary structures. In particular, the holding members might have an infinitely variable adjustability up to a maximum stroke, in order to allow for a fine adjustment of the width of the safety gate to the width of the passage. According to the respective embodiment, a pressure force might as well be enacted upon the stationary structures by means of the holding members.

In an embodiment, an insertion depth can be adjusted by discrete selection of an orientation of the stop member with respect to the support opening. Here a discrete selection of an orientation can be understood as a defined offset of the orientation, wherein other orientations are not available. According to an embodiment, it might be, for example, a rotation of the extension part by 180° about the longitudinal direction. Also, a rotation of 90° about the longitudinal direction could be thought of or even a rotation of 180° about a vertical direction.

In general, a discrete selection of the insertion depth might can be realized by other means, such as, for example, a modification of the stop member by insertion of a pin in different positions, or the like.

In an embodiment of the invention, the extension part can be formed as an essentially prismatic body, wherein the stop member comprises a cam which is protruding sideways above the body. The body might, for example, have a square or rectangular cross section, wherein the cam protrudes on just one side and, caused by rotation of 180° about the longitudinal direction, interacts with a different stop within the support opening.

The extension part can have a central orifice for receiving the holding member. Thereby, for example, a projection of a threaded shaft of the holding member, said projection having a variably adjustable length, can protrude into the extension part. A face side of the extension part can, in a simple and effective embodiment, form the stop for a countering nut of the holding member, which is preferably adjustable.

Accordingly, the holding member can be designed such that it has a shaft, in particular a threaded shaft, which extends in the longitudinal direction and comprises a counter-member, in particular a nut, which is continuously adjustable at the shaft.

In an embodiment of the invention, the extension part, in the first insertion depth, can be essentially completely recessed in the support opening, wherein the extension part, in the second insertion depth, protrudes out of the support opening by at least a part of its length. This allows for a receipt of the extension part at the safety gate even if not used as an extension, it being less likely for the extension part to get lost. Particularly preferably, it might have a function even in this arrangement, for example as a counter-support of the holding member.

In an embodiment, in which an integrated construction with few parts is provided, the support opening can be arranged at a handle part of the barrier member, wherein the handle part comprises a lock for a releasable locking of a door member provided in the barrier member. As a rule, the safety gate should have several support openings in order to receive several of the extensions parts. For instance, an upper support opening can be arranged in the handle part and a bottom support opening can be arranged at a bottom cross frame.

Generally, the widths of openings arranged at the safety gate, like for example the free space between neighboring grid rods, should not exceed predefined sizes for safety reasons. Such sizes could be defined, for example, in official norms or rules. Thereby, special demands are directed to the design of extension parts with respect to their number, variability and simplicity of assembly.

In an embodiment, a further extension part is provided, wherein the further extension part comprises at least one grid rod, which adjoins to the side of the barrier member. This allows for a larger extension without, under safety aspects, a large opening being created at which a child could be injured.

In an embodiment, the further extension part has a headpiece with an orifice, wherein the first extension part engages into the headpiece up to a stop which is provided in the orifice. The orifice might, for example, serve for receiving of a protrusion of a threaded shaft of the holding member, which protrusion might partially or completely protrude through the headpiece, but has no structural function for the assembly of the extension parts.

In an embodiment it is provided that the further extension part can be inserted into the support opening as an alternative to the first extension part. For example, this could be a second stage of a multi-stage extension, wherein the first extension part is actually not used, but is comprised in the total package of the safety gate.

In an embodiment, at least three further extension parts can be provided in addition to the first extension part, the further extension parts in each case having at least one grid rod being arranged next to the barrier member, and wherein the further extension parts can be plugged onto each other, respectively. Thereby, a greater variety of combinations of extensions can be generated. In case of a preferred embodiment, the three further extension parts differs from each other respectively, forming a second, third and fourth extension part. Preferably, different extensions of the safety gate with increasing width are provided thereby: a first extension as a combination of the first with the second extension part; a second extension as a combination of the second with the third extension part; and/or a third extension as a combination of all of the totally four extension parts.

The object of the invention is further achieved for an extension module. Such extension module might be offered as a package together with the safety gate, or as a separate item for an optional supplement of the safety gate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a plane view of a safety gate according to an embodiment of the invention with a maximum extension;

FIG. 2 shows a spatial view of the safety gate of FIG. 1 without extension;

FIG. 3 shows a spatial view of the safety gate of FIG. 1 with, compared to FIG. 1, a reduced extension;

FIG. 4 shows a spatial detail view of the safety gate of FIG. 2;

FIG. 5 shows the safety gate of FIG. 4 with an extension part removed;

FIG. 6 shows a detail enlargement of the safety gate of FIG. 3;

FIG. 7 shows a spatial exploded detail enlargement of the safety gate of FIG. 1;

FIG. 8 shows a first extension part of the safety gate of FIG. 1 to FIG. 7 in different plain views, a sectional view along the line A-A and a spatial view;

FIG. 9 to FIG. 11 show further extension parts of the safety gate of FIG. 1, which are different from each other respectively;

FIG. 12 shows a combination of the extension parts of FIG. 9 and FIG. 11;

FIG. 13 shows a headpiece of the extension part of FIG. 10 in different plain views, a sectional view along the line A-A and a spatial view; and

FIG. 14 shows a handle part of the safety gate of FIG. 1 in different plain views, a sectional view along the line A-A and a spatial view.

### DETAILED DESCRIPTION

The safety gate displayed in FIG. 1 comprises a centrally arranged barrier member 1, which adjoins to an extension module 2 on each side. the barrier member 1 has a frame with a lower crossbar 1b and two vertical, side bars 1a, 1c.

A pivotable door member 3 is hinged in the frame 1a, 1b, 1c, the frame being a rigid structure and having a predefined width. The door member 3 presently has a plurality of parallel grid rods for blocking a passage, but might also comprise a solid plate, a net-shaped grid or similar. A handle part 4, having a door-sided part 4b and a frame-sided part 4a, is arranged at an upper corner of the door member and the upper end of the adjoining side bar 1a, wherein the door member 3 can be releasably fixed and operated by means of the handle part. Presently, but not necessarily, a latching slide 5 for operating of the lock is arranged at the frame-sided part 4a of the handle part 4.

In the present case, the door member comprises a further, bottom lock 6 with a springs-loaded catch. Releasing of the door member is enabled by lifting about a defined stroke after operating the latching slide 5, a swivel 7 of the door member 3 being connected with the other bar 1c and designed accordingly. The swivel 7 comprises a lower swivel part 7a and a spring-driven repositioning device for an automatic closing of the door member 3.

Each of the extension modules 2 comprises several extension parts 8, 9, 10, 11, which have different design and are plugged into each other, respectively.

The extension parts 8, 9, 10, 11 of the two extension modules 2 are respectively identical, hence the extension modules 2 being identical with each other.

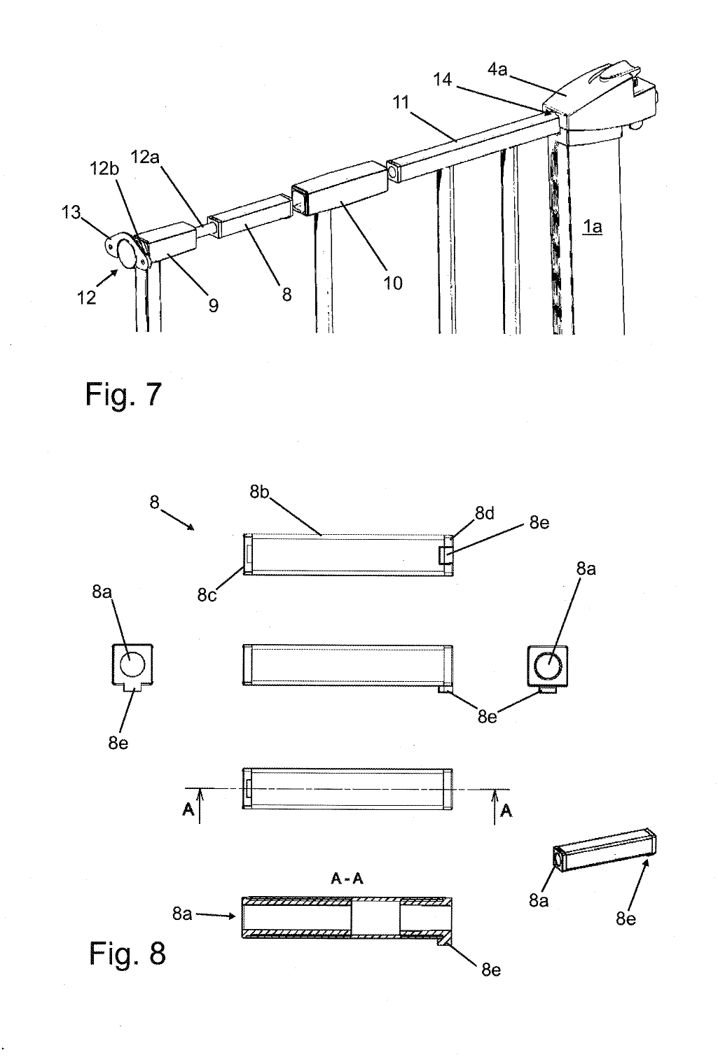

An upper and a lower holding member 12 is, in each case, arranged at the end of the extension modules 2 and/or at the respectively terminal extension part 9 (see FIG. 7 as well). The holding member 12 is designed, in a known manner, as a clamping screw with a threaded shaft 12a and a countering nut 12b. All of the extension parts 8, 9, 10, 11 have orifices 8a, 9a, 10a, 11a extending in a longitudinal direction, a protrusion of the threaded shaft being able to protrude into the orifices. The countering nut 12b is supported against the end face of the outer extension part 9.

A support plate 12c, for instance a plastic buffer, is arranged at the end of the clamping screw 12. The support plate can engage into a counter-support 13 being fixed at a stationary structure (door post, wall etc.) in a completely or partially positive manner, or it might be supported against the stationary structure in a just clamping manner (frictional contact).

Hence, a continuous adjustment to the width of the passage to be blocked between the stationary structures is enabled by means of the holding member 12. For safety reasons, the adjustable stroke of the holding member is limited, for example to about 6 cm, in order to prevent a too large opening with danger of injury.

The further adjustment to the width of the passage is done by selecting one out of several stages of the extension by means of the extension parts 8, 9, 10, 11.

The first extension part 8 is formed as an essentially prismatic body with presently square cross section (see FIG. 8 in particular). It comprises a central tube part 8b made from metal, plastic parts 8c, 8d being terminally inserted into the tube part. One of the plastic parts 8d is designed as a stop member, having a cam 8e as a support protruding sideways over the tube part 8b.

Central orifices are provided in the plastic parts 8c, 8d respectively, summing up to providing an orifice 8a for the receiving of a protrusion of the threaded shaft 12a in the extension part 8.

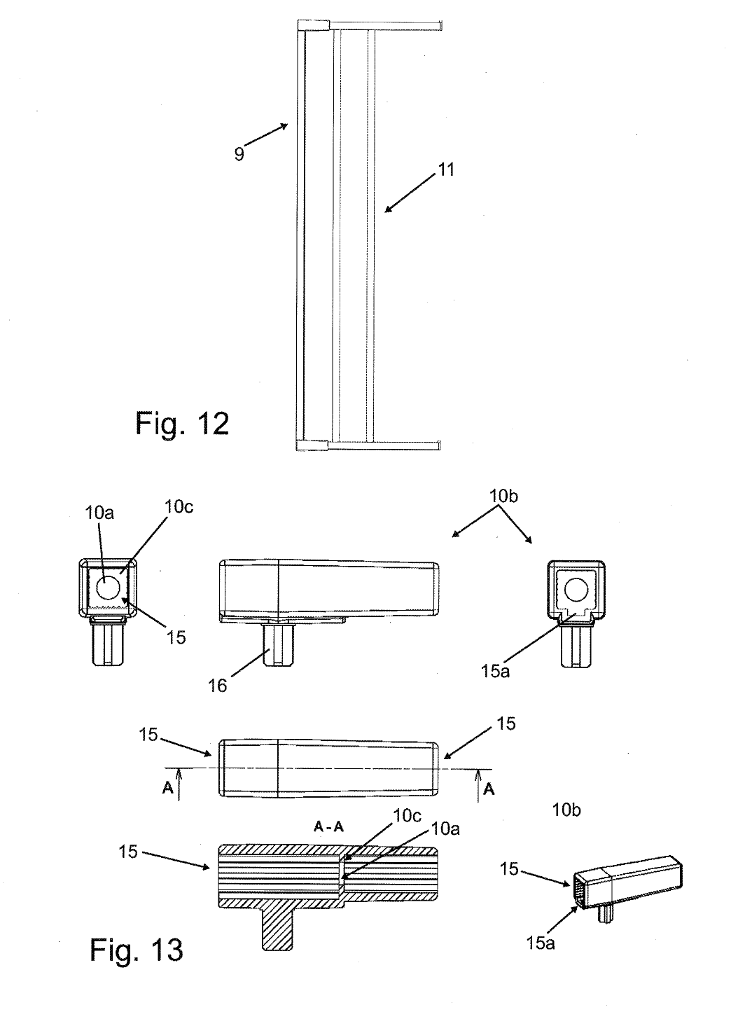

A total of 4 support openings 14 are provided in the barrier member 1, into which one out of four first extension parts 8, or also further extension parts 11 (in the case of an alternative combination of extension parts, see FIG. 12), can be inserted respectively.

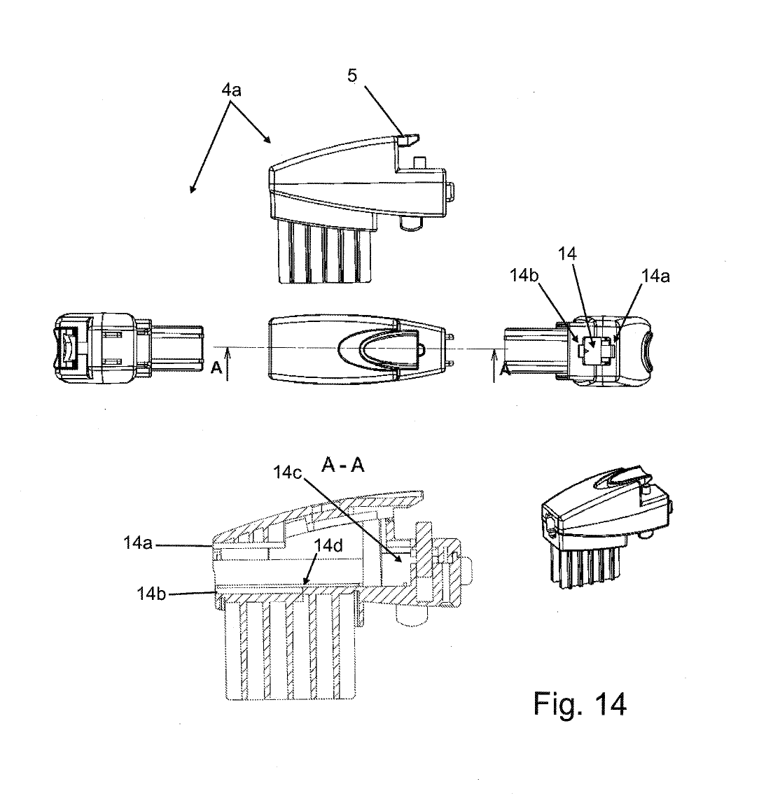

The extension part 8a can abut in the support opening 14 in two different insertion depths because of the interaction of its stop member 8d, 8e with one of two corresponding grooves 14a, 14b (see FIG. 14). One of the support openings 14 is arranged at the handle part 4, namely at the part 4a (see FIG. 14) which is arranged at the upper end of the bar 1a. This handle part 4a is displayed in FIG. 14 in detail, in particular for reasons of better clarification of the design of the support opening 14.

The first, upper of the grooves 14a extends up to a maximum depth of the support opening 14, in which a bottom 14c of the support opening is present. The second, lower of the grooves 14b protrudes up to just about half of this depth into the support opening 14, the end of the groove 14b forming a counter-support 14d.

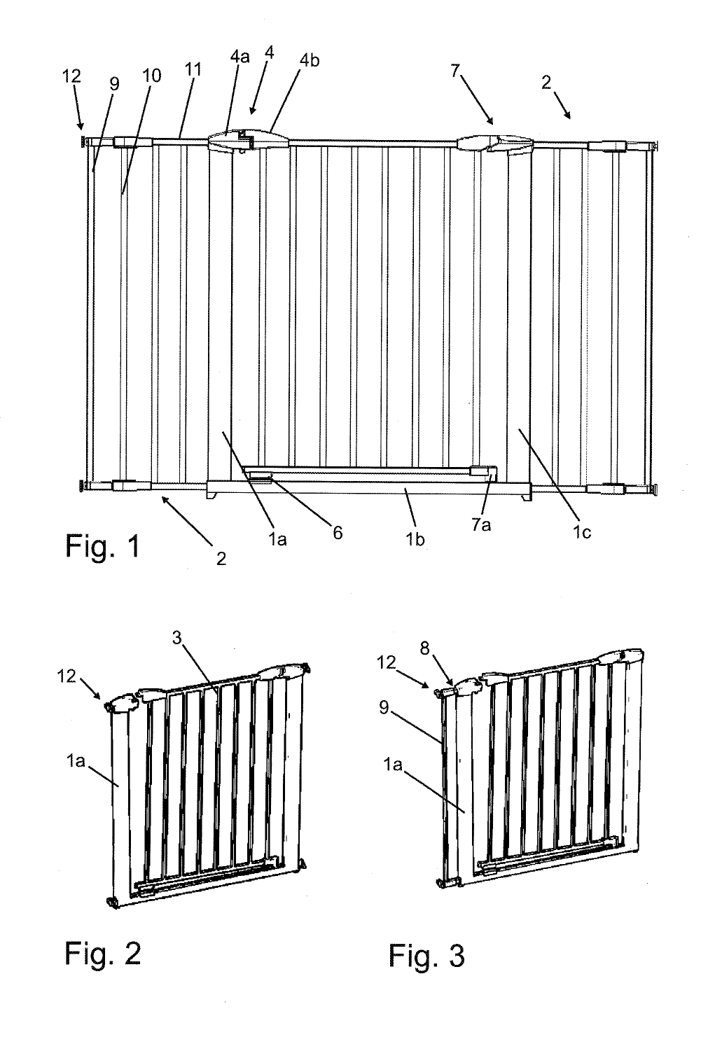

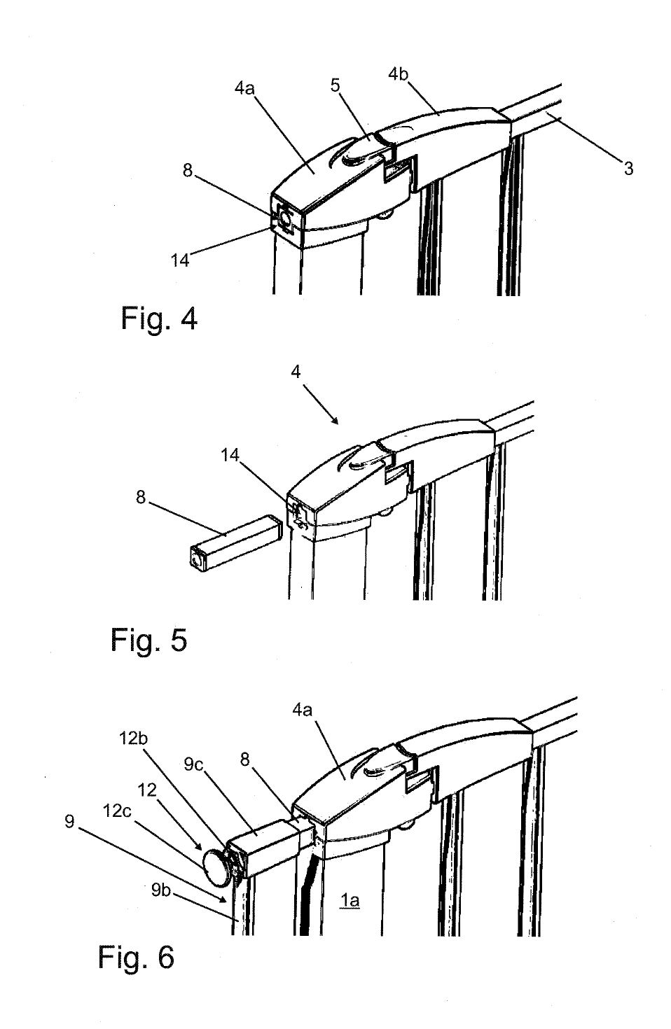

If the first extension part 8 is oriented about its longitudinal direction such that the cam 8e engages into the first groove 14a, the first extension part 8 can be inserted completely, i.e. over its entire length, into the support opening 14. This state is displayed in FIG. 2 (with holding members 12) and/or in FIG. 4. In this case, none of the further extension parts 9, 10, 11 is used (non-extended safety gate and/or variant with minimum width). The holding members 12 are then plugged directly onto the barrier member 1, for example the countering nut 12b being supported against the end face of the handle part 4a. In this case, the threaded shafts 12a protrude only into the orifices 8a of the first extension parts 8.

If the extension part 8 is turned by 180° about its longitudinal direction with respect to the above described orientation and/or this orientation is discretely selected, the cam 8e engages into the lower groove 14b. This allows for insertion of the extension part 8 up to just about half of its length, until the cam 8e abuts at the stop 14d of the groove 14b.

In this position, the extension part 8 protrudes by about half of its length from the support opening.

In case of an alternative embodiment, a part of the extension part could protrude from the support opening 14 for all of the insertion depths, such that not more than a section, but not the entire extension part 8 is inserted.

In case of a further alternative embodiment not displayed, more than two discretely selectable insertion depths of the first extension part 8 can be provided. For example, the upper groove 14a could have a stop in a first depth, e.g. ⅔ of a total length of the body 8, and the lower groove 14b could have a stop at an insertion depth of ⅓ of the length of the body 8. These depths would be achieved if the cam 8e of the extension part 8 is inserted head first into the respective groove 14a, 14b. But if the extension part 8 is turned by 180° about the vertical axis and inserted head first with the other plastic part 8c provided without a cam, it would be inserted completely and/or up to the stop 14c. In case of further embodiments, further grooves of different depths could be provided at the remaining walls of the support opening 14, such that respective discrete turns by 90° about the longitudinal axis would result in different insertion depths. Even further differentiation of insertion depths could be achieved by respective change of the cross section of the body 8, for example to a hexagonal or even round cross section, allowing for a respective larger number of discretely selectable orientations.

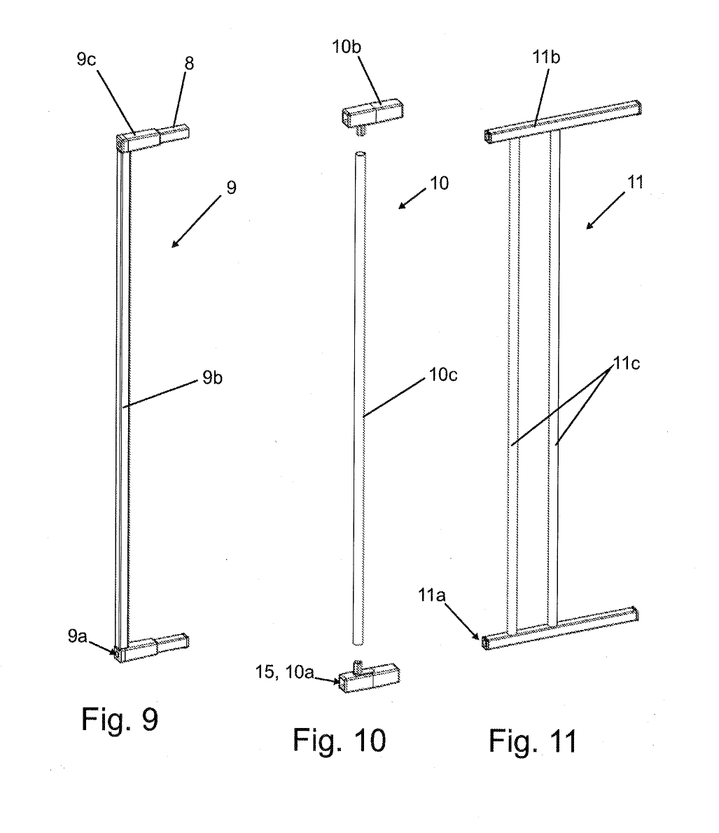

Basically, a first stage of the extension of the shown embodiment can now take place by inserting the holding members 12 directly into the protruding extension parts 8. Anyway, in the present embodiment the dimension of the parts are chosen such that a first stage of the extension is achieved by further plugging the (first) further extension part 9 onto the first extension parts 8. The further extension part 9 is a grid rod 9b with two terminal, identical headpieces with the orifices 9a for receiving the threaded shaft 12a being provided therein. It is pointed out that in the display of FIG. 9, the first two extension parts 8 are already inserted into the headpieces 9c.

A view of the safety gate in this first stage of an extension is shown in FIG. 3 (total view) and in FIG. 6 (detail enlargement).

A second stage of the extension (see FIG. 12) is reached if, instead of the first extension part 8, a (second) further extension part 11 is combined with the extension part 9. The further extension part 11 has upper and lower bars 11b as headpieces, a plurality of (presently two) grid rods 11c extending in-between. The upper and lower bars 11b comply with the first extension part 8 in their cross section and, just like this but for a greater length, are designed to be inserted into the support openings 14. In the present example, plastic parts are inserted at end sides of the bars 11b, which allow for an insertion into the support openings up to the maximum insertion depth. Hence no cams are provided in positions which engage into the lower groove 14b. Nevertheless, in a possible variant this can be provided.

Again, in this second stage of the extension, the extension part 9 is the outer part in which the holding members 12 are received.

A third, maximum stage of the extension (see FIG. 1, FIG. 7) is achieved when a (third) further extension part 10 is added. This extension part includes two headpieces (10b) made from plastics, a single grid rod 10c extending in-between and being plugged onto tenons 16 of the headpieces 10b. The headpieces 10b are shown in detail in FIG. 13. They have a central orifice 15 extending in the longitudinal direction and with a square cross section. A stop barrier 10c is provided within this orifice, the stop barrier itself having a round orifice 10a for a possible penetration by the protruding threaded shaft 12a. Dependent on the respective adjustment of the countering nut, a penetration by the threaded shaft 12a is not necessarily provided. In any case, the threaded shaft 12a has no supporting function here, but just protrudes through the opening 10a with undefined clearance.

The first extension part 8 is inserted into the orifice 15 and/or the headpiece 10b from one side, until is abuts at the stop barrier 10c. From The (second) further extension part 11 is inserted into the orifice 15 from the other side, until it abuts at the stop barrier 10c as well. In order to prevent colliding with the cams 8e, according recesses 15a are provided in the orifice 15. Presently, these recesses are only provided at the side of the first extension part 8. This allows for the assembly only with a defined orientation of all parts.

In case of the third stage of the extension, the order of the extension parts, starting from the barrier member and/or the support openings is:

Second further extension part 11; then third further extension part 10; then first extension part 8; then first further extension part 9.

Here, like in the case of all other combinations, the first further extension part 9 is the outermost of the extension parts and accordingly the one which carries the holding members 12.

By the systems described above, stages of extension are made possible in an easy manner, which allows for a respective extension by one grid rod in a given safety distance. The safety distance between two grid rods is about 6 cm, according to the used material. This also defines the allowed stroke of a fine adjustment by means of the holding members. The three stages of the extension of an extension module 2 with respect to the non-extended barrier member 1 are presently 7 cm, 18 cm and 25 cm. By use of two extension modules, respective further stages and sub-combinations can be obtained.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A safety gate for children or pets, the safety gate comprising:
a barrier member with a predefined width for barring an opening with a larger width between stationary structures;
at least one holding member configured to fix the barrier member at the structures; and
at least a first extension part provided between the holding member and the barrier member for bridging over at least a part of a difference between the width of the opening and the width of the barrier member,
wherein the extension part comprises at least one section with a stop member, the at least one section configured to extend in a longitudinal direction and configured to be insertable into a support opening by an insertion depth, and
wherein the stop member abuts selectably in a first insertion depth and in at least a second insertion depth, which is different from the first insertion depth.

2. The safety gate according to claim 1, wherein the insertion depth is adjustable by discrete selection of an orientation of the stop member with respect to the support opening.

3. The safety gate according to claim 1, wherein the extension part is formed as an essentially prismatic body, and wherein the stop member comprises a cam that protrudes sideways above the body.

4. The safety gate according to claim 1, wherein the extension part has a central orifice that is adapted to receive the holding member.

5. The safety gate according to claim 1, wherein the holding member has a shaft that extends in a longitudinal direction, and wherein the holding member comprises a counter-member that is continuously adjustable at the shaft.

6. The safety gate according to claim 1, the extension part, in the first insertion depth, is essentially completely recessed in the support opening, and wherein the extension part, in the second insertion depth, protrudes out of the support opening by at least a part of its length.

7. The safety gate according to claim 1, wherein the support opening is arranged at a handle part of the barrier member, and wherein the handle part comprises a lock for a releasable locking of a door member provided in the barrier member.

8. The safety gate according to claim 1, wherein a further extension part is provided, and wherein the further extension part comprises at least one grid rod that adjoins to the side of the barrier member.

9. The safety gate according to claim 8, wherein the further extension part has a headpiece with an orifice, and wherein the first extension part engages into the headpiece up to a stop that is provided in the orifice.

10. The safety gate according to claim 8, wherein the further extension part is configured to be insertable into the support opening.

11. The safety gate according to claim 8, wherein at least three further extension parts are provided in addition to the first extension part, the further extension parts in each case comprising at least one grid rod arranged next to the barrier member, and wherein the further extension parts are configured to be plugged onto each other, respectively.

12. An extension module for a safety gate according to claim 1, the extension module comprising at least the first extension part.

13. The safety gate according to claim 5, wherein the shaft is a threaded shaft.

14. The safety gate according to claim 5, wherein the counter-member is a nut.
